(19) United States
(12) Patent Application Publication
(10) Pub. No.: US 2009/0172917 A1
(43) Pub. Date: Jul. 9, 2009

(54) Access door lever

(76) Inventor: Hope Landin, Livermore, CA (US)

Correspondence Address: Oswald & Yap, 16148 Sand Canyon, Irvine, CA, 92618, US

(21) Appl. No.: 12/319,385

(22) Filed: Jan. 7, 2009

Related U.S. Application Data
(60) Provisional application No. 61/019,325, filed on Jan. 7, 2008.

(51) Int. Cl. E05B 1/00

(52) U.S. Cl. 16/421

(57) ABSTRACT

The Access Door Lever is a device which provides an easier way to open a door with a traditional doorknob. In one embodiment, the invention will fit over a traditional doorknob, snap in place with finger-like extensions, which will grip the doorknob. The extension is coated with a material which will provide a secure grip between the doorknob and extension. The design and location of the extension(s) allow for a snug fit with the doorknob. A handle which is connected to the extension(s) allow the invention to function as a lever on the doorknob.

### RELATED APPLICATION

This application claims the benefit of U.S. Provisional Application No. 61/019,325.

### STATEMENT RE: FEDERALLY SPONSORED RESEARCH OR DEVELOPMENT

The claimed invention was not sponsored by any federally sponsored research or development.

### REFERENCE TO COMPACT DISCS

There were no compact disc(s) which were submitted with the application.

### BACKGROUND OF THE INVENTION

Many individuals have difficulties wrapping their hands around and operating a traditional doorknob such as a cylindrical, round or spherical doorknob. For example, elderly users or those individuals with hand debilities such as arthritis or venal carpal syndrome lack the physical strength to turn doorknobs, resulting in these individuals leaving the door(s) open to maintain access through the door. This situation can result in lack of privacy, a dangerous or security concern, and may result in increased heating and cooling bills as well. Without an easier way to open a door with a traditional doorknob, some individuals may be unable to enter or move freely inside their home. A device is needed which will offer a more convenient method for opening a door, making any traditional doorknob such as a cylindrical, round or spherical doorknob easier to turn. Ideally, such a device would be less expensive than retrofitting the existing door with new hardware, and would be easy to install on virtually any door equipped with a traditional doorknob, ensuring that youngsters, elderly, or other individuals with debilities in operating traditional doorknobs, may access any room in the home with a simple push of the lever.

### BRIEF SUMMARY OF THE INVENTION

The object of the invention is to provide a lever to operate a traditional doorknob. The invention will fit over a traditional doorknob or standard doorknob, and snap in place with finger-like extension(s), which will grip the doorknob. The extension(s) with gripping material, perform the function of fingers in gripping and turning a doorknob. The invention snaps in place when the extension(s) slip over and grips the doorknob. The extension(s) are covered with a material which will provide a secure grip between the doorknob and finger-like extensions. A handle is attached to the base of the extension(s) by a collar which will allow the invention to function as a lever on the doorknob.

### BRIEF DESCRIPTION OF THE DRAWINGS

FIG. 1 is a perspective view of one embodiment of the invention which has been placed on a doorknob.

FIG. 2 is a perspective view from the top of one embodiment of the invention without the lever attached.

FIG. 3 is a perspective view from the bottom of one embodiment of the invention without the lever attached.

FIG. 4 is a cross-sectional side view of one embodiment of the invention to depict the placement of a material which will provide a grip between the doorknob and extension(s).

FIG. 5 is a perspective view of one embodiment of the invention which provides additional grip between the doorknob and extension.

FIG. 6 is a perspective view of one embodiment of the invention with a cover over the invention for aesthetic reasons and to provide additional grip between the doorknob and extension.

### DETAILED DESCRIPTION OF THE INVENTION

The invention involves a device which will slip over, grip and act as a lever on a traditional doorknob. Such an invention is particularly useful for individuals suffering from one of numerous hand debilities which renders it difficult or painful to grasp or twist a traditional doorknob.

In the following description, numerous specific details are set forth, in order to provide a thorough understanding of the invention. It will be obvious, however, to one skilled in the art that the invention may be practiced without these specific details or dimensions. Some well-known methods and structures have not been set forth in order not to unnecessarily obscure the description of the invention.

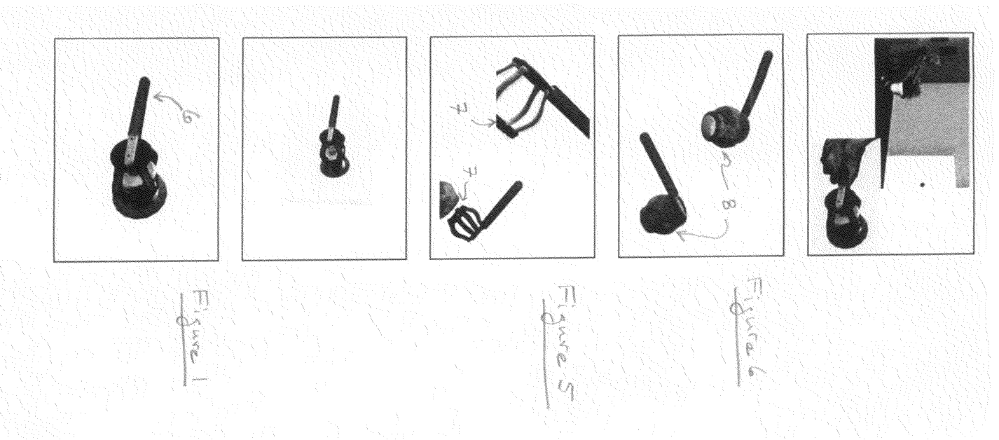

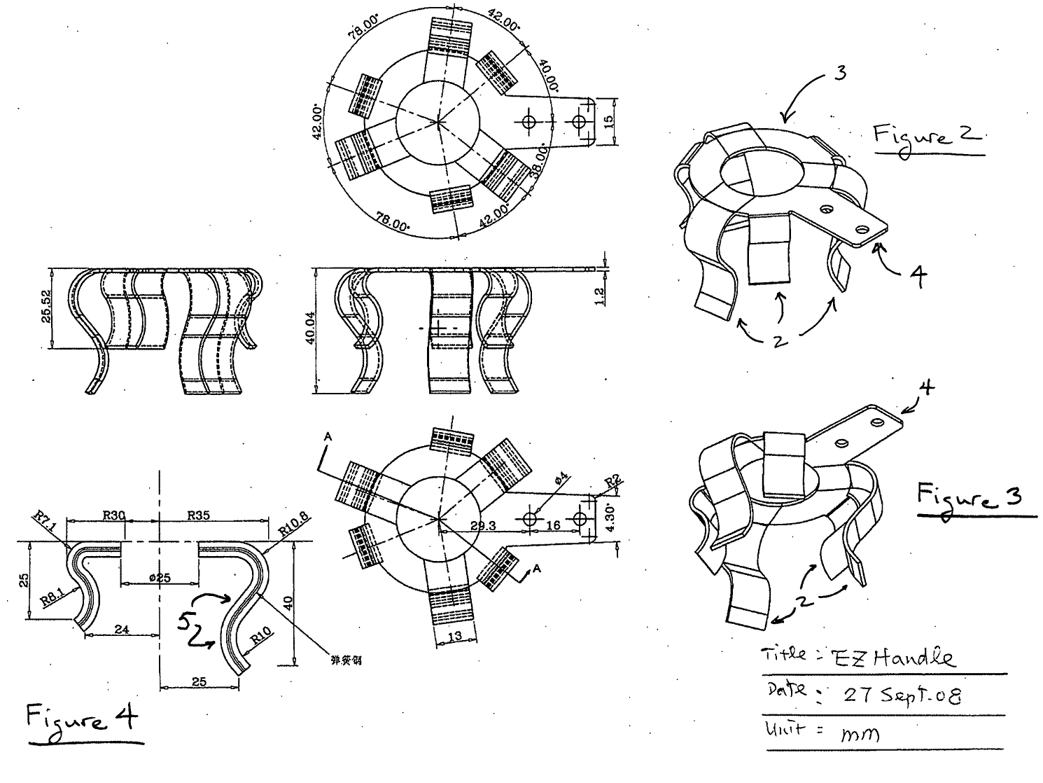

The invention can be better understood by reference to FIG. 1. A traditional doorknob can be turned or twisted to effectuate movement of the door's striker in order to open the door. The invention 1 slips over the doorknob.

The extension(s) 2 are coated with a material 5 which will provide a grip between the extension and the doorknob. This material 5 may comprise of rubber, elastomeric material, neoprene, polymer or some other material which can be applied on the extension 2 to provide a gripping force, but will allow the extension 2 to slip over the doorknob. The design and placement of the extension(s) 2 allow the extension(s) to snugly grip the doorknob through the gripping material 5. A collar 3 connects the extension(s) 2 to a lever connection 4. A lever 6 is connected to the lever connection 4.

Another embodiment of the invention is depicted by reference to FIG. 5. To provide additional gripping pressure between the extension(s) 2 and doorknob, a band 7 may be placed on the extension(s). The band 7 may comprise of rubber band(s), elastomeric material, neoprene, polymer or some other material which can be installed on the extension 2 to provide a gripping force.

Another embodiment of the invention is depicted by reference to FIG. 6. To provide additional gripping pressure between the extension(s) 2 and doorknob, a cover 8 may be placed on the extension(s). The cover 8 may comprise of rubber, elastomeric material, neoprene, polymer or some other material which can be installed on the extension 2 to provide a gripping force, but will allow the cover 8 and invention 1 to slip over the doorknob.

The invention has been described in detail with particular reference to preferred embodiments thereof. As will be apparent to those skilled in the art in the light of the accompanying disclosure, many alterations, substitutions, modifications, and variations are possible in the practice of the invention without departing from the spirit and scope of the invention.

We claim:

1. A device for turning a knob, comprising:
a. one or more extensions which will grip a knob, which extension(s) are connected to a collar, which collar is connected to a lever attachment, which lever attachment is connected to a lever, which allows the lever to turn or twist the knob.

2. A device as described in claim 1, wherein additional gripping force between the extension(s) and knob, is obtained by band or cover.

3. A device for turning a knob, comprising:
a. one or more extensions which will slip over a knob, snap in place, grip the knob;
b. lever which is connected to the extension(s) which will allow the lever to twist or turn the knob.

4. A device as described in claim 3, wherein additional gripping force between the extension(s) and knob, is obtained by band or cover.
